(19) United States
(12) Patent Application Publication
(10) Pub. No.: US 2003/0137960 A1
(43) Pub. Date: Jul. 24, 2003

(54) Interworking in a communication system

(76) Inventor: Marc Greis, Irving, TX (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/220,545

(22) PCT Filed: Feb. 9, 2001
(86) PCT No.: PCT/EP01/01452

(30) Foreign Application Priority Data
Mar. 6, 2000 (GB) 0005363.7

(51) Int. Cl. H04Q 7/24

(52) U.S. Cl. 370/338; 370/352

(57) ABSTRACT

The present invention relates to a method and arrangements in a communication system including at least two groups of differently arranged elements. A control message is generated that can be interpreted by at least one element of a first group of elements and at least one element of the second group of elements. An object containing control information that is transparent for the elements of the second group is added into the message, whereby the operation of the elements of the first group may be controlled based on the control information contained in the object.

### FIELD OF THE INVENTION

The present invention relates to interworking between different functions of a telecommunications system.

### BACKGROUND OF THE INVENTION

Telecommunications networks typically operate in accordance with a given standard or specification which sets out what the various elements of the network are permitted to do and how that should be achieved. For example, the standard or specification may define whether the user, or more precisely, user equipment or terminal is provided with circuit switched or packet switched service. The standard or specification may also define the communication protocols and/or parameters which shall be used for the connection. In other words, the standards and/or specifications define the “rules” on which the communication within a communication system can be based on. Examples of the different standards and/or specifications include, without limiting to these, specifications such as GSM (Global System for Mobile communications) or various GSM based systems (such as GPRS: General Packet Radio Service), AMPS (American Mobile Phone System), DAMPS (Digital AMPS), WCDMA (Wideband Code Division Multiple Access) or TD/CDMA in UMTS (Time Division/Code Division Multiple Access in Universal Mobile Telecommunications System), IMT 2000 and so on.

In a cellular communication system a base station serves mobile stations or similar terminal apparatus (mobile station MS in the GSM, User Equipment UE in the UMTS) via a wireless interface. Each of the cells of the cellular system can be served by an appropriate transceiver apparatus. For example, in the WCDMA radio access network the cell is served by Node B, which is connected to and controlled by an element called as a radio network controller (RNC) node. In the GSM radio network the cell is served by a base station (BTS), which is connected to and controlled by a base station controller (BSC) node. The BSC/RNC element may be connected to and controlled by a mobile switching center (MSC) or similar facility. The BSC/RNC may also be connected to and controlled by a serving GPRS support node (SGSN). The MSCs of a network are typically interconnected and there may be one or more Gateway MSC (GMSC) for connecting the cellular network to other telecommunication networks. The SGSN may be connected to a Gateway GPRS support node (GGSN) for connecting the mobile network to the Internet and other packet switched networks.

Thus, although the mobile station may be in communication via only one controller and/or gateway node at the time, it may also communicate via several different nodes. The nodes the mobile station is connected with may also be configured and operated based on different standards and/or specifications. The differences in the standards and/or specifications may cause difficulties with respect to the interworking of the various elements of the different network systems. The following will describe an example of the possible incompability problem in the context of Quality of Service (QoS) signaling between the different elements and protocols of a communication system comprising one or more packet switched UMTS/GRPS networks.

The General Packet Radio Service GPRS relates to the transfer of data to and from mobile stations. Typically, the GPRS standard is provided in conjunction with the Global System for Mobile communications GSM standard. The GSM standard is a circuit switched service and is originally designed for speech services. There are elements of the GSM standard and the GPRS standard which are in common. The GPRS networks are described in more detail e.g. in 3GPP Technical Specification 3G TS 23.060 version 3.2.0, “General Packet Radio Service (GPRS); Service description; Stage 2”, January 2000. This document is incorporated herein by reference. An adaptation of the GPRS standard is also being proposed for use with the third generation standard UMTS, which typically uses code division multiple access. The packet data part of the UMTS is contained in the above referenced 23.060 specification, i.e. 23.060 applies for packet switched data both for the UMTS and the GPRS.

To negotiate an end-to-end QoS between terminals in UMTS/GRPS networks and terminals in other data networks such as the IP (Internet Protocol) or X.25 based networks, a conventional fixed IP network, or another UMTS/GRPS network, a protocol such as Resource Reservation Protocol RSVP may be used.

However, the inventor has found that in the current interworking between the RSVP QoS signaling and the UMTS/GPRS QoS mechanisms (i.e. so called PDPcontext activation) the RSVP messages do not carry enough QoS information to determine the full set of UMTS/GPRS QoS parameters from these messages. More particularly, the RSVP PATH message carries QoS information in a “SENDER_TSPEC” object. The “SENDER_TSPEC” object contains only the following QoS parameters: ‘Token Bucket Rate’, ‘Token Bucket Size’, ‘Peak Data Rate’, ‘Minimum Policed Unit’, ‘Maximum Packet Size’. Said UMTS/GPRS QoS and the parameters thereof are defined e.g. in 3GPP Technical Specification 3G TS 23.107 version 3.1.0, “QoS Concept and Architecture”, October 1999. A more detailed description of the RSVP PATH message can be found e.g. from document by Braden, R., et al, “Resource ReSerVation Protocol (RSVP)—Version 1 Functional Specification”, IETF RFC 2205, September 1997. The “SENDER_TSPEC” object is defined e.g. by Wroclawski, J. in document “The Use of RSVP with IETF Integrated Services”, IETF RFC 2210, September 1997. These three documents are incorporated herein by reference.

It is not possible for a network element within a UMTS network to determine essential UMTS QoS parameters like ‘Traffic Class’ and ‘Transfer Delay’ alone from the QoS parameters contained in this SENDER_TSPEC object.

The RSVP RESV message may carry an additional “RSPEC” (within a “FLOWSPEC” object) containing a rate and a slack term, which may be used to derive the ‘Transfer Delay’ parameter. However, the mapping may be problematic since the RSPEC (like all other RSVP QoS parameters) is meant to be used for end-to-end QoS while the UMTS Transfer Delay parameter only defines the delay within the UMTS network. In addition, the RSPEC applies to queuing delay, while in the UMTS/GPRS QoS specifies transfer delay.

The UMTS QoS parameters and the RSVP QoS parameters as contained in a FLOWSPEC object and a possible mapping between these parameters are shown in Table 1. This table shows the UMTS specific QoS parameters which can not be derived from the RSVP QoS parameters.

TABLE 1
UMTS and RSVP QoS Parameters

| UMTS Attributes | RSVP Parameters |
|---|---|
| Traffic Class | Service Class? |
| Maximum Bitrate | Peak Data Rate |
| Guaranteed Bitrate | Token Bucket Rate |
| Maximum SDU Size | Maximum Packet Size |
| Delivery Order | — |
| SDU Format Information | — |
| SDU Error Ratio | — |
| Residual Bit Error Ratio | — |
| Delivery of Erroneous SDUs | — |
| Transfer Delay | — |
| Traffic Handling Priority | — |
| Allocation/Retention Priority | — |
| — | Token Bucket Size |
| — | Rspec (Rate/Slack Term) |
| — | Minimum Policed Unit |

It also has to be noted that there are only three RSVP/IntServ service classes (Best Effort, Controlled Load, Guaranteed Service), but four UMTS service classes (Conversational, Streaming, Interactive, Background) which complicates further the mapping between these two parameters.

### SUMMARY OF THE INVENTION

It is an aim of the embodiments of the present invention to address one or several of the above problems.

According to one aspect of the present invention, there is provided a method in a communication system including a first subsystem and a second subsystem, the method comprising: generating a control message that can be interpreted by at least one element of the first subsystem and at least one element of the second subsystem; adding to the control message an object containing control information that is transparent for the elements of the second subsystem; transmitting the control message via the first and second subsystems; and controlling the operation of at least one of the elements of the first subsystem based on the control information contained in the object.

The first subsystem may comprise a packet switched network providing wireless services for the users thereof. The second subsystem may also comprises a data network that is based on a packet switched communication protocol that is different from the communication protocol used by the first subsystem. The message may be transmitted further to a third subsystem comprising at least one element capable of interpreting the information carried by the object. The third subsystem may be based on substantially similar operational principles than the first subsystem.

The communication system may comprise at least a first terminal and a second terminal, the first terminal belonging to the first subsystem, and wherein a connection between the two terminals is negotiated based on a quality of service mechanism for packet data. The control message may comprise a resource reservation protocol message. The object may contain at least one quality of service parameter that is required by the first subsystem for connection set-up purposes.

According to another aspect of the present invention there is provided a communication system comprising: a first subsystem comprising a first plurality of elements for transmitting messages; a second subsystem comprising a second plurality of elements for transmitting messages; a controller for generating a control message that can be interpreted by at least one element of the first subsystem and at least one element of the second subsystem; and a controller for adding to the control message an object containing control information that is transparent for the elements of the second subsystem, wherein the arrangement is such that operation of at least one of the elements of the first subsystem is controlled based on the control information contained in the object while the elements of the second subsystem are not affected by the control information contained in the object.

According to another aspect of the present invention there is provided a user equipment for a system providing wireless packet switched communication between a first and second packet switched networks, the user equipment comprising: a controller for generating a control message to be signaled from the first network to the second network, the control message being readable by elements of a first predefined group of elements of the first and second networks; and a controller for adding to the control message an object containing control information, said message being readable only by elements of a second predefined group of elements of the first and second networks.

According to another aspect of the present invention there is provided a control message in a communication system that provides wireless packet data communication between first and second networks, the control message comprising: a portion that can be interpreted by elements of a first predefined group of elements of the first and second networks; and an object containing control information, said object being readable only by elements of a second predefined group of elements of the first and second networks.

The embodiments of the invention may improve interworking between the various functions, such as protocols and mechanisms. For example, interworking of the Resource Reservation Protocol RSVP and packet data QoS mechanisms of a packet switched service such as the Universal Mobile Telecommunication System UMTS or the General Packet Radio Service GPRS may be improved. In a more specific embodiment, the interworking between two UMTS/GPRS networks may be improved since it provides a possibility for an end-to-end signalling between UMTS networks based on RSVP messages.

### BRIEF DESCRIPTION OF DRAWINGS

For better understanding of the present invention, reference will now be made by way of example to the accompanying drawings in which:

FIG. 1 shows a communication system where the embodiments of the present invention may be used; and

FIG. 2 is a flowchart illustrating the operation of one embodiment of the present invention.

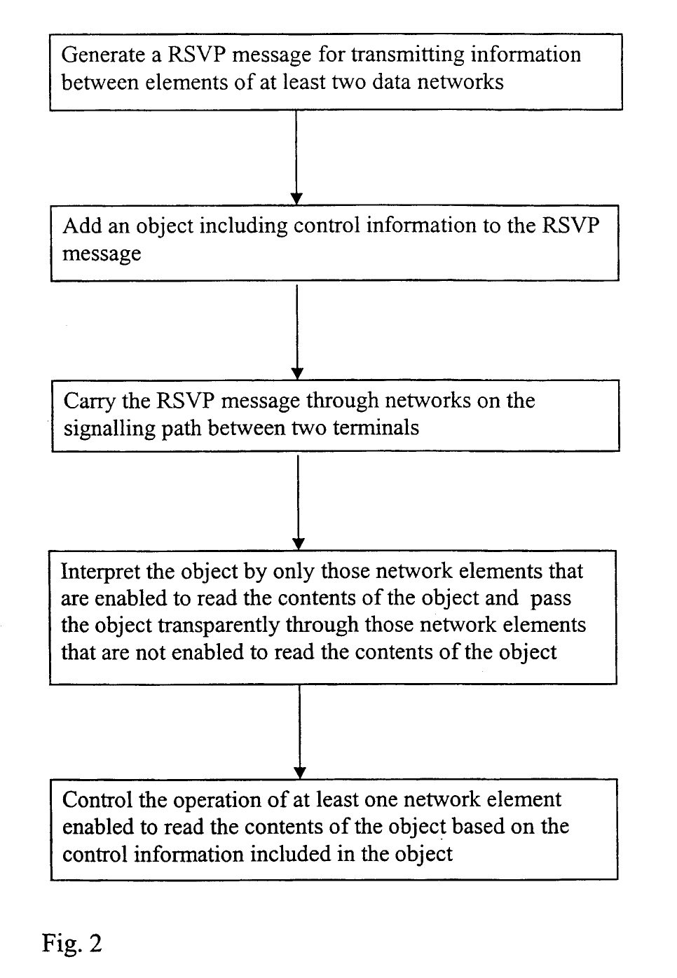

### DESCRIPTION OF PREFERRED EMBODIMENTS OF THE INVENTION

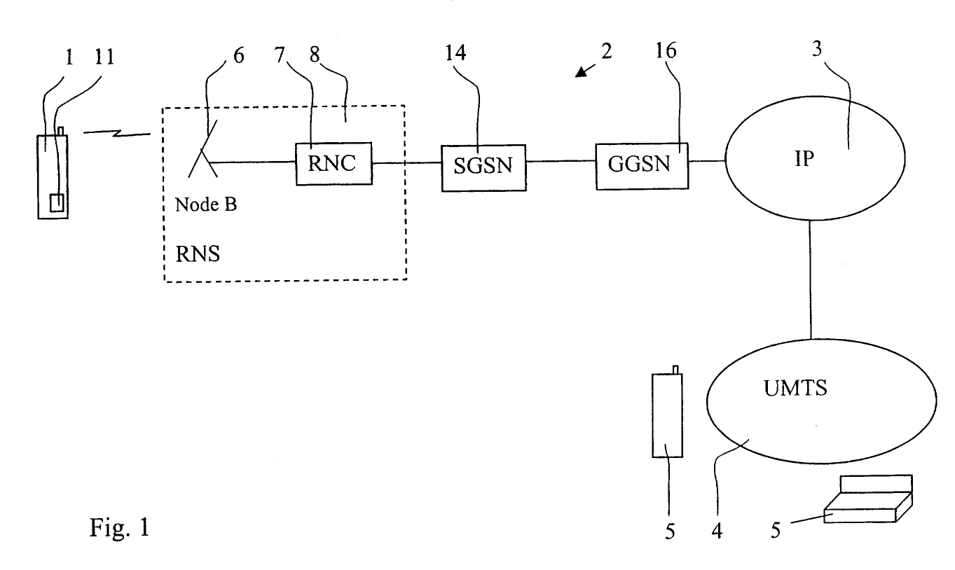

Reference is made to FIG. 1 which shows a communication system in which the embodiments of the present invention may be employed. The area covered by the communication system is divided into a plurality of cells (not shown). Each cell has associated therewith a base station 6. Depending on the standard being used by the network, the base station is sometimes referred to as node B, for example in the third generation standards. The term base station will be used in this document to encompass all elements which transmit to mobile stations 1 or the like via the air interface. The mobile stations 1 or other user equipment is arranged to communicate with the respective base station. The mobile station 1 may be associated with terminal equipment 11, as will be explained later.

The embodiment of the invention is described in the context of a UMTS (Universal Mobile Telecommunications System) and a GPRS (General Packet radio Service) and communications involving packet data. However, it should be appreciated that embodiments of the present invention are applicable to any other communication system which deals with packet data, non-packet data or even voice communication or the like, such as the IMT 2000, wireless LAN or different access networks.

The elements of a UMTS network system 2 will now be discussed in more detail. The mobile station or user equipment 1 is arranged to communicate via the air interface with a respective base station 6. The base station is controlled by a radio network controller RNC 7. The radio network controller RNC and the base station may sometimes be referred to as the radio network subsystem RNS 8 or radio access network RAN. It should be appreciated that a UMTS network is typically provided with more than one RNC, and that each radio network controller is arranged generally to control more than one base station 6 although only one base station is shown in FIG. 1. The elements of the RNS can be included in either or both of the RNC and the base station. This is an implementation issue.

The radio network subsystem 8 may be connected to a SGSN (serving GPRS support node) 14. The SGSN 14 keeps track of the mobile station's location and performs security functions and access control. The functions of the SGSN are defined e.g. in the 3GPP specification 33.060. The SGSN 14 is connected to a GGSN (gateway GPRS support node) 16. The GGSN 16 provides interworking with external packet switched networks, i.e. the GGSN acts as a gateway between the UMTS data network 2 and an external network 3, such as an IP based data network. The functions of a typical GGSN are also defined in the 3GPP specification.

FIG. 1 shows further a second UMTS network 4. The second UMTS network may be of a substantially similar design than the first UMTS network 2.

Although not shown, the network system 2 may also be connected to conventional telecommunication networks, such as to a GSM based cellular public land mobile network (PLMN) or to a public switched telephone network (PSTN). The various networks may be interconnected to each other via appropriate interfaces and/or gateways.

The following describes an embodiment for improving interworking between the Resource Reservation Protocol RSVP and packet data QoS mechanisms of the Universal Mobile Telecommunication System UMTS and/or the General Packet Radio Service GPRS. The application of RSVP for carrying UMTS QoS parameters by defining a new RSVP object which can be interpreted by UMTS network elements while the object is carried transparently through other networks or links between two UMTS networks such that the element of the other networks or links are not aware of this additional object of the RSVP message. The described embodiments may be applied for UMTS networks as well as GPRS networks and any hybrids thereof.

A feature of the RSVP protocol is that it is modular. A RSVP message consists of a pre-defined set of objects, where the object type is indicated by the Class-Num octet in the header of each object. If an RSVP process in a network element encounters an unknown object while it processes an RSVP message, there are alternative possibilities for how to process this object and the whole message, based on the two high-order bits in the object's Class-Num octet. For example, if:

Class-Num=0bbbbbbb

the entire message containing this object is rejected and an error message is generated;

Class-Num=10bbbbbb

the network element ignores the object and does not forward it and no error message is generated;

Class-Num=11bbbbbb

the network element ignores the object but forwards the object in all messages resulting from the processed message.

The last mentioned alternative may thus be used for the extension of the RSVP protocol with network-specific objects. In principle, it is possible to add any desired information into these objects. It is thus possible to have objects that only apply for e.g. for the GGSN of a network, and/or objects which only apply e.g. for the mobile station MS. The added objects may be carried transparently through other networks and/or elements that are based on different standards, specifications or settings. That is, the forwarding of the RSVP messages is not affected in any way by such an added object in networks which are not able to interpret it. All those network elements or nodes that are not able to interpret the object will still be able to interpret the rest of the RSVP message.

In accordance with an embodiment of the present invention, a previously undefined RSVP object (referred to in the following as “UMTS QoS Object”) with a Class-Num octet which matches the mask “11bbbbbb” is adapted to carry UMTS QoS (Quality of Service) information. The RSVP object may carry all UMTS QoS parameters which are defined e.g. in the above referred 3GPP Technical specification “QoS Concept and Architecture”. The RSVP object may also carry only a subset of these parameters. The RSVP object may also carry QoS information which is currently not contained in the RSVP QoS parameters and which can be used to determine all the UMTS QoS parameters or a subset of these parameters.

The UMTS QoS information can be used by the network elements within the UMTS network 2 (the elements include the mobile station 1 as well as attached terminal equipment) to extend the information contained especially in the PATH messages. The UMTS QoS information can also be used in other RSVP messages to provide the UMTS network 2 with additional QoS information. The additional information is not included in conventional RSVP messages. The network elements can be adapted to use the information contained in the UMTS QoS object to avoid mapping inconsistencies between the RSVP QoS parameters and the UMTS QoS parameters. The UMTS QoS information can also be used to enable the transfer of UMTS QoS information between two remote end points or two UMTS networks within RSVP messages.

The use of UMTS QoS information requires that there are network elements within the UMTS network 2 which are able to generate this information and that there are elements within the UMTS network 2, the receiving UMTS network or other data network which are able to process and use this information as described above.

According to an alternative embodiment, a Class-Num octet may be used which matches the above described second possible mask “10bbbbbb” to avoid possible interference with proprietary solutions in other access networks. That is, the object is not forwarded from the particular element interpreting the message and the object and thus the object cannot cause interference. However, the interference problem can also be avoided by standardizing the Class-Num for the UMTS QoS Object within the appropriate instances.

The additional object within the RSVP message may be interpreted internally within one UMTS network but not in end-to-end QoS negotiation (e.g. it could be stripped from outgoing RSVP messages by the GGSN 16 or any other appropriate element). The object can also be used in the end-to-end QoS negotiation between two UMTS networks so that a terminal in a UMTS network can be informed about the exact UMTS QoS requirements of a terminal in another UMTS network.

The first network element (including the terminal equipment 11 and/or the mobile station 1) in the UMTS network 2 which processes an RSVP message and which is able to perform a mapping between RSVP and UMTS QoS parameters is preferably used for the mapping and adding a UMTS QoS object to the forwarded RSVP message containing the resulting parameters. This object may also be added by the application that requests for the QoS. A possibility is to add the object by drivers or utilities within the terminal equipment 11. The user may control the terminal equipment 11, e.g. by means of the user interface (typically keypad) of the mobile station 1.

The UMTS QoS Object could be added to a RSVP message in an application running in the terminal equipment 11 which is integrated or attached to the mobile station 1. The application is both RSVP-aware and aware of the UMTS access network 8. In other words, the application is able to signal a RSVP message, is aware of the fact that the UE is attached to a UMTS network and knows the UMTS QoS (i.e. is enabled to add the UMTS QoS object to the RSVP message). The adding of the object may also occur in drivers or other utility applications running in the terminal equipment. A mobile station which is RSVP-aware may also be used. When the object is added at the user equipment or any other unit that is controllable by the user, the user is facilitated with a direct control over the UMTS QoS parameters transmitted to the network. This may be an advantage, since the user typically has the best or first hand knowledge of the type of the traffic that is to be transmitted (e.g. video data or speech data).

The UMTS QoS parameters may also be determined in a mapping procedure from the RSVP QoS parameters by a network element of the UMTS network 2. The network element may not be under the user's direct control. For example, a UMTS QoS Object may also be added to a RSVP message by the GGSN 16 upon receipt of an RSVP message. This allows for the signaling of UMTS QoS requirements to remote endpoints. It also allows signaling by a separate network element within the UMTS network which is responsible for QoS negotiation (e.g. bandwidth broker, etc.).

It should be appreciated that the UMTS QoS Object could be added to RSVP messages in several other locations as well and that the above examples do not exclude these.

The terminal equipment may be an external device such as a laptop computer which is attached to the mobile station 1.

The UMTS QoS object may be interpreted in several elements of the communication system depending the application. It should be appreciated that the following list of the possible network elements is not indented to be complete.

The interpretation may be accomplished in an RSVP aware mobile station 5 which receives an RSVP message from attached terminal equipment to trigger a PDP context activation procedure with the QoS parameters contained in the RSVP message. The interpretation may also be accomplished in an RSVP aware mobile station 5 which receives an RSVP message from a remote terminal which is implemented either in a UMTS-network or which is capable of adding a UMTS QoS Object to RSVP messages to trigger a PDP context activation procedure with the QoS parameters contained in the RSVP message.

A possible node for interpretation is a GGSN node which receives incoming or outgoing RSVP messages and which may have to trigger PDP context activation procedures based on these messages, perform admission control or map RSVP QoS parameters to UMTS QoS parameters.

In the embodiments the RSVP or any similar protocol providing a possibility to add one or more objects therein may be employed for carrying UMTS QoS parameters or one or more other parameters required by the network by defining a new object into the message. The added object can be interpreted by the elements of the particular network the one or more parameters are indented for while the object can be carried transparently through networks which do not base the operation thereof on the one or more parameters. The object may be added to the message such that the other networks may not even become aware of this additional part of the message. The addition of a UMTS QoS Object to RSVP messages allows applications, drivers or user-controlled utility applications which are aware of both RSVP and UMTS QoS to take full control of the UMTS QoS instead of leaving the mapping between RSVP QoS parameters and UMTS QoS parameters to other network elements.

The QoS requirements signaled by the RSVP messages can be split up in QoS requirements for the access network (contained in the UMTS QoS Object) and end-to-end QoS requirements (contained in the SENDER_TSPEC and FLOWSPEC objects).

RSVP messages containing the UMTS QoS Object can be transferred transparently through one or more external data networks, such as TCP/IP Internet and/or X.25 networks, no matter if these networks are aware of the RSVP modification or not. RSVP messages containing the UMTS QoS Object will neither be discarded nor cause error messages in network nodes which are not able to interpret this object. This allows for the signaling of QoS requirements between terminals in two UMTS networks.

The added object can be implemented as an optional feature. If a communication application is not able to create this object, it may be created e.g. by an RSVP-aware MT or by the GGSN. This allows for high flexibility (e.g. the operator may want to configure network elements to ignore or override the object) and even for proprietary implementations without causing any interworking problems with “traditional” RSVP.

According to a further embodiment the RSVP message is used for signaling the quality of service QoS communication between two data networks providing wireless services for the users thereof. The required QoS information is transmitted in the object, and no other QoS signaling is required.

It should be appreciated that whilst embodiments of the present invention have been described in relation to UMTS and GPRS networks and RSVP messages, embodiments of the present invention are applicable to any other suitable type of networks and protocols.

In an embodiment the communication between two data networks is not transmitted via a third network that is located between said two networks, but the subsystem between the two networks comprises an appropriate link or gateway. This type of embodiment is provided, for example, when the IP network 3 of FIG. 1 is replaced by an appropriate link between the UMTS networks 2 and 4. An arrangement where the elements of the link between the two data networks may not be enabled to interpret the message is also possible. Correspondingly, the arrangement may be such that elements of a network between the two data networks may not be provided with means for interpreting any part of the message. According to a further embodiment the elements of a data network are divided in at least two subgroups such that the first group may interpret an object that is transparent for the second subgroup.

The data is described as being in packet form. In alternative embodiments of the invention the data may be sent in any suitable format.

It is also noted herein that while the above describes exemplifying embodiments of the invention, there are several variations and modifications which may be made to the disclosed solution without departing from the scope of the present invention as defined in the appended claims.

1. A method in a communication system including a first subsystem and a second subsystem, the method comprising:
generating a control message that can be interpreted by at least one element of the first subsystem and at least one element of the second subsystem;
adding to the control message an object containing control information that is transparent for the elements of the second subsystem;
transmitting the control message via the first and second subsystems; and
controlling the operation of at least one of the elements of the first subsystem based on the control information contained in the object.

2. A method as claimed in claim 1, wherein the first subsystem comprises a packet switched network providing wireless services for the users thereof.

3. A method as claimed in claim 1 or 2, wherein the first subsystem is based on a universal mobile telephone system and/or a general packet radio services.

4. A method as claimed in any preceding claim, wherein the second subsystem comprises a data network that is based on a packet switched communication protocol that is different from the communication protocol used by the first subsystem.

5. A method as claimed in any preceding claim, wherein the second subsystem is an internet protocol based data network.

6. A method as claimed in any preceding claim, wherein the message is transmitted further to a third subsystem comprising at least one element capable of interpreting the information carried by the object.

7. A method as claimed in claim 6, wherein the third subsystem is based on substantially similar operational principles than the first subsystem.

8. A method as claimed in any of the preceding claims, wherein the communication system comprises at least a first terminal and a second terminal, the first terminal belonging to the first subsystem, and wherein a connection between the two terminals is negotiated based on a quality of service mechanism for packet data.

9. A method as claimed in claim 8, wherein the second terminal belongs to the third subsystem.

10. A method as claimed in any preceding claim, wherein the control message comprises a resource reservation protocol message.

11. A method as claimed in any preceding claim, wherein the object contains at least one quality of service parameter that is required by the first subsystem for connection set-up purposes.

12. A method as claimed in claim 11, wherein the object carries all parameters required for the connection set-up.

13. A method as claimed in claim 11, wherein the object carries a subset of parameters required for the connection set-up.

14. A method as claimed in any of claims 1 to 10, wherein quality of service information is determined based on information carried by the object.

15. A method as claimed in any preceding claim, wherein additional quality of service information is determined based on the information carried by the object, and the additional information is used for avoiding inconsistencies between the quality of services parameters of different communication networks.

16. A method as claimed in any preceding claim, wherein the networks elements of the second subsystem ignore the object and forward the object in all messages that result from processing of the control message.

17. A method as claimed in any preceding claim, wherein the object includes at least one bit instructing the element processing the control message whether the object should be ignored or not by the element.

18. A method as claimed in claim 17, wherein a high order bit is included in the class-number octet of the object.

19. A method as claimed in any preceding claim, wherein a network element reads the information content of the object and removes the object from the message before forwarding the message.

20. A method as claimed in any preceding claim, wherein a network element in the communication path generates the objects and adds the object in the control message.

21. A method as claimed in claim 20, wherein the element comprises a mobile station.

22. A method as claimed in claim 20, wherein the element comprises an element of a radio access network of the first subsystem.

23. A method as claimed in claim 20, wherein the element comprises a gateway node between two different networks.

24. A method as claimed in any of claims 20 to 23, wherein the user of the network element is enabled to control the use of the objects.

25. A method as claimed in any preceding claim, wherein the object is interpreted in a terminal that terminates the connection.

26. A method as claimed in any preceding claim when appended to claim 6, wherein the object is interpreted in an element of the third subsystem.

27. A method as claimed in any preceding claim, wherein the object is interpreted in a gateway node between different networks.

28. A communication system comprising:
a first subsystem comprising a first plurality of elements for transmitting messages;
a second subsystem comprising a second plurality of elements for transmitting messages;
a controller for generating a control message that can be interpreted by at least one element of the first subsystem and at least one element of the second subsystem; and
a controller for adding to the control message an object containing control information that is transparent for the elements of the second subsystem, wherein the arrangement is such that operation of at least one of the elements of the first subsystem is controlled based on the control information contained in the object while the elements of the second subsystem are not affected by the control information contained in the object.

29. A communication system as claimed in claim 28, wherein the first subsystem comprises a packet switched network providing wireless services for the users thereof.

30. A communication system as claimed in claim 28 or 29, wherein the first subsystem is based on universal mobile telephone system specifications and/or a general packet radio service specifications.

31. A communication system as claimed in any of claims 28 to 30, wherein the second subsystem comprises a data network that is based on a packet switched communication protocol that is different from the communication protocol used by the first subsystem.

32. A communication system as claimed in any of claims 28 to 31, wherein the second subsystem is a data network that is based on the Internet protocol.

33. A communication system as claimed in any preceding claim, wherein the first subsystem comprises a first network and a second network, the message being transmitted from the first network to the second network via the second subsystem.

34. A communication system as claimed in claim 33, wherein the first and second networks are based on similar operational principles.

35. A communication system as claimed in any of claims 28 to 34, wherein the communication system comprises at least a first terminal and a second terminal, the first terminal belonging to the first subsystem, and wherein a connection between the two terminals is adapted to be negotiated based on a quality of service mechanism for packet data.

36. A communication system as claimed in any of the claims 28 to 35, wherein the control message comprises a resource reservation protocol message.

37. A communication system as claimed in any of claims 28 to 36, wherein the object contains at least one quality of service parameter that is required by the first subsystem for connection set-up purposes.

38. A communication system as claimed in any of claims 28 to 37, wherein quality of service information is determined based on information carried by the object.

39. A communication system as claimed in any of claims 28 to 38, wherein the networks elements of the second subsystem are adapted to ignore the object and forward the object in all messages that result from processing of the control message.

40. A communication system as claimed in any of claims 28 to 39, wherein the network element in the communication path that generates the objects and adds the object in the control message is one of the following: a mobile station; an element of a radio access network of the first subsystem; a gateway node between two different networks.

41. A communication system as claimed in any of claims 28 to 40, wherein the object is interpreted by one of the following: a terminal that terminates the connection; an element of the third subsystem; a gateway node between different networks.

42. A communication system as claimed in claim 33, wherein the second subsystem comprises a link between the first and the second networks.

43. A user equipment for a system providing wireless packet switched communication between a first and second packet switched networks, the user equipment comprising:
a controller for generating a control message to be signaled from the first network to the second network, the control message being readable by elements of a first predefined group of elements of the first and second networks; and
a controller for adding to the control message an object containing control information, said message being readable only by elements of a second predefined group of elements of the first and second networks.

44. A user equipment as claimed in claim 43, wherein the message comprises a resource reservation protocol message and the object contains quality of service information.

45. A control message in a communication system that provides wireless packet data communication between first and second networks, the control message comprising:
a portion that can be interpreted by elements of a first predefined group of elements of the first and second networks; and
an object containing control information, said object being readable only by elements of a second predefined group of elements of the first and second networks.

46. A user equipment as claimed in claim 45, wherein the message comprises a resource reservation protocol message and the object contains quality of service information.
